(19) United States
(12) Patent Application Publication
(10) Pub. No.: US 2023/0256706 A1
(43) Pub. Date: Aug. 17, 2023

(54) AEROGEL-CONTAINING INSULATION LAYER

(71) Applicant: Outlast Technologies GmbH, Heidenheim (DE)

(72) Inventors: Volker Schuster, Koenigsbronn (DE); Stefan Saur, Aalen (DE)

(21) Appl. No.: 18/015,811

(22) PCT Filed: Jun. 23, 2021
(86) PCT No.: PCT/EP2021/067157

§ 371 Date: Jan. 12, 2023

(30) Foreign Application Priority Data
Jul. 15, 2020 (DE) 10 2020 118 734.3

(51) Int. Cl. B32B 5/24; B32B 5/02

(52) U.S. Cl. CPC B32B 5/245; B32B 5/022; B32B 2266/126; B32B 2307/304; B32B 2266/04; B32B 2307/73

(57) ABSTRACT

Applying aerogel-containing insulation layer(s) to an article. The insulation layer comprising: aerogel particles; and at least one binder, comprising the steps of: providing the article to be coated; mixing the aerogel particles with the particles of a pulverulent binder and/or a pulverulent solid, for example expanded glass, to give a particle mixture; applying the particle mixture to the article to be coated by scattering the particle mixture onto the article to be coated; and activating the at least one binder of the at least one insulation layer, in order to provide a bond of the particle mixture to the article, wherein the aerogel particles are present in the particle mixture in a proportion of 5 to 95 percent by weight of the particle mixture.

### CLAIM OF PRIORITY UNDER 35 U.S.C. § 119

This patent application is a National Stage of International Application No. PCT/EP2021/067157 filed on Jun. 23, 2021 which claims the benefit and priority of German Patent Application No. 10 2020 118 734.3, entitled “AEROGEL-CONTAINING INSULATION LAYER”, filed on Jul. 15, 2020, the disclosure of which is incorporated herein by reference in its entirety.

### TECHNICAL FIELD

The present invention generally relates to a method of applying an aerogel-containing insulation layer to an article.

### BACKGROUND

The insulation layer may serve as thermal insulation (also referred to as heat insulation), or otherwise used for structure-borne sound insulation and footfall sound insulation, or insulation of vibrations.

Conventional thermal insulation materials or structure-borne sound and footfall sound insulation materials are based on polystyrene, polyolefins and polyurethanes and are produced using blowing agents, for example CFCs, CO2 or pentane. Also known is the use of air as a blowing agent. The blowing agent is incorporated in the cells of the foam and is responsible for the high insulation capacity. However, such blowing agents pollute the environment since they escape gradually into the atmosphere. Other structure-borne sound and footfall sound insulation materials based on mineral fibre wool or glass fibre wool can emit fibres and/or fibre fragments in the course of production, assembly and disassembly thereof, and over their service life. This leads to pollution of the environment and impairs the health of people who work with or are exposed to these substances. In the past, aerogels have been found to be useful as novel insulation materials, especially for thermal insulation, since they do not have the disadvantages mentioned.

In association with insulation mats in the field of building insulation, it is known, for example, to provide a multilayer mat system having a first insulation mat having 20 to 90 percent by weight (wt %) of an aerogel. An aerogel refers here to a gel formed with air as a dispersion medium. This includes three kinds of aerogels that differ with regard to the manner in which they are dried.

For instance, an aerogel in a narrower sense refers to a wet gel which is dried by evaporation above the characteristic critical point (i.e. at temperatures above the critical evaporation temperature and/or proceeding from pressures above the critical pressure). This does not give rise to any capillary pressure, and slight shrinkage is to be expected when the liquid is removed.

By contrast, a wet gel which is dried under subcritical conditions, for example to form a liquid-vapour boundary phase, is referred to as a xerogel. The material here has high porosity with a high surface area in combination with a very small pore size.

In addition, a further interpretation of the term aerogel includes dried gel products that have been obtained in a freeze-drying process. These are regularly referred to as cryogels.

Irrespective of the manner of drying, the typical structures of the aerogel form during the sol-gel transition. After formation of the solid gel structure, the outward shape may be altered solely by comminution, for example by grinding. The material is too brittle for most other modes of forming.

The prior art discloses a multitude of different aerogel compositions including both organic and inorganic aerogels. Inorganic aerogels are often based on metal oxides, such as silicon oxide (silica), carbides and alumina. Organic aerogels, meanwhile, comprise carbon aerogels and polymeric aerogels, for example polyamide aerogels.

Typically, aerogels having very good thermal insulation properties have particularly low density, within a range, for example, from 0.01 g/cm³ to 0.3 g/cm³. Such materials may have a thermal conductivity of 12 mW/mK or even less under standard conditions, i.e. at a room temperature of 20° C. and mean atmospheric pressure of 1013.25 hPa. On account of their low density, however, pure aerogels and aerogel particles are extremely fragile and simultaneously difficult to handle in further processing.

Therefore, the prior art discloses a wide variety of different solutions for production of a composite material comprising aerogel (aerogel composite), in which, for example, a fibre-reinforced aerogel layer is applied by means of an acrylic binder (WO2007/086819) on a plate or applied in a free-flowing sol-gel solution by means of an impregnation method to a matrix of reinforced fibres (US2002/0094426). In the case of the latter solution, after the impregnation, the sol-gel solution applied still has to be dried in such a way that the desired pores of the aerogel that are crucial for the thermal insulation capacity are not destroyed. Accordingly, the production of such mats is comparatively complex.

A further alternative solution already known in the art is to provide the aerogel in particle form and to bind it to a layer or surface, for example by means of a chemical binder (cf. U.S. Pat. No. 6,485,805), to incorporate the aerogel particles into a composite material with thermoplastic fibres (U.S. Pat. No. 6,479,416) or to wet the aerogel particles with a wetting agent and then to introduce them into a slurry or solution with fibres and water, which is subsequently dried to give a composite fabric (WO2006/065904 and WO2014/004366). In this connection, reference is also made to US 2008/0287561 A1.

WO2012/013817 A1 describes a specific method for producing aerogel-containing composites. This solution is intended to produce, in particular, a composite having improved mechanical strength. In the context of the method described, raw materials provided are fibres in an amount of 3 to 80 wt % of the total weight of the starting material and aerogel particles in an amount of 10 to 75 wt % of the total weight of the starting material, and these are mixed with one another in a first air stream. This is intended to produce a particularly homogeneous mixture, which increases the mechanical strength of the composite produced later. It is possible to add a chemical binder as a further raw material to the mixture or even before the mixing. In a specific embodiment, the composite additionally comprises a layer of nonwoven or felt, to which the mixed raw materials are applied and are compressed together with this layer.

In practice, it has been found that the mixing process has to be effected in a sealed working chamber since the aerogel particles otherwise spread everywhere in the air as a result of their own low weight. This is especially promoted by the mixing process using an air stream. Thus, this process requires costly equipment in order to enable a safe working environment and simultaneously to ensure efficient mixing.

DE 195 48 128 A1 further describes a composite having at least one layer of fibrous web comprising thermoplastic fibre material and aerogel particles. Here too, the problem at the outset is that the high porosity of aerogels leads to low mechanical stability both of the gel (from which the aerogel is dried) and of the aerogel itself. The solution here is to bind the aerogel particles to the partly molten thermoplastic fibres. In addition, the partly molten thermoplastic fibres become bonded to one another when they consolidate the fibres to form a stable web.

The fibrous web is produced using staple fibres. While the web is being laid by the known methods, i.e. by the web production process, the pelletized aerogel is introduced by scattering, taking care to ensure a very homogeneous distribution of the pellets. This is achieved by conventional scattering apparatuses. A comparable method is likewise known from EP 0 799 353 B1. Here too, however, scattering is possible only in a sealed working chamber, or the aerogel pellets have to be sufficiently large and hence heavy to avoid unwanted distribution in the air and achieve controlled application.

These known prior art processes are limited to the introduction of an aerogel into a fibrous web, wherein the aerogel is scattered directly into the web as it forms during the production method.

In addition, DE 197 02 240 A1 and EP 0 850 206 B1 describe a process for producing an aerogel composite body, in which the aerogel particles are mixed with a binder (DE′240 A1) or an adhesive (EP′206 B1) and optionally with fibres. The composite body preferably comprises three layers, of which the middle layer is aerogel-containing. The proportion of aerogel particles in the at least one aerogel-containing layer should be within a range from 5 to 97 percent by volume (vol %). The binder in the at least one aerogel-containing layer forms a matrix that binds or surrounds the aerogel particles, and forms a continuous phase through the at least one aerogel-containing layer, and possibly through the entire composite. Binders may, for example, be adhesives or plastics or bicomponent fibres, wherein the binder should preferably not penetrate into the interior of the porous aerogel particles in order to impair the heat-conducting properties thereof as little as possible. In one embodiment, the aerogel particles may be sprayed with the binder and hence coated in this way. Alternatively or additionally, the aerogel particles and optionally fibres may also be mixed with the binder.

In the field of textile production, US 2018/0313001 A1 discloses a process for producing a synthetic fibre having a proportion of aerogel particles of about 0.1 to 15 percent by weight (also wt % hereinafter) and a proportion of 85 to 99.9 wt % of a polymer. The aerogel particles and the polymer are mixed here with one another and co-extruded or formed in some other way to give an intermediate (for example to give pellets).

In practice, the above-described production methods have been found to be very inconvenient and costly, especially since the handling of aerogel particles is problematic in industrial processing on account of their low weight. Furthermore, the aerogel, in a multitude of the methods described, is introduced into or applied to the end product during the production thereof. This limits the field of application; it is no longer possible to subsequently apply an aerogel-containing layer to a finished article.

Alternatively, the aerogel is applied to the finished product in a solution and subsequently has to be dried in a complex drying method, in which it has to be ensured that the thermal insulation properties of the aerogel are not impaired. In this connection, reference is also made to US 2016/0138212 A1.

In fibre production, moreover, the incorporation of aerogel is problematic and limited to comparatively small proportions, which also limits the efficacy of the thermal insulation properties of the finished textile.

In powder coating of metallic surfaces, according to the disclosure of US 2017/0225276 A1, the use of carbon aerogel particles in combination with polymer particles is known, wherein the particles are mixed with one another and sprayed onto the surface of a pipe to be coated and immediately thereafter soldered on by means of a laser beam. The particle mixture serves here to bridge a gap between a first metal structure, for example of an inner pipe, and a second metal structure, for example of an outer pipe.

Finally, reference is also made to US 2002/0187302 A1 which discloses in a neighbouring technical field, namely the production of hygiene articles, a solution with a mixture of absorbent macroporous particles and binder particles being applied to a first substrate by means of a knurled roller. In this solution the mixture is, hence, directly applied to and pressed into the substrate without any air gap that needs to be overcome by the mixture. This known solution, however, has the disadvantage of the width of the knurled roller limiting the width of the substrate to be layered and, hence, limiting the scope of application.

In order to counter at least some of these disadvantages, the present invention proposes a unique method of applying an aerogel-containing insulation layer to an article.

### SUMMARY

Embodiments disclosed herein address the above stated needs by disclosing a method of applying an aerogel-containing insulation layer to an article.

In some aspects, the techniques described herein relate to a method of applying at least one aerogel-containing insulation layer to an article, wherein the insulation layer includes: aerogel particles; and at least one binder, including the steps of: providing the article to be coated; mixing the aerogel particles with the particles of a pulverulent binder and/or a pulverulent solid, for example expanded glass, to give a particle mixture; applying the particle mixture to the article to be coated by scattering the particle mixture onto the article to be coated; and activating the at least one binder of the at least one insulation layer, in order to provide a bond of the particle mixture to the article, wherein the aerogel particles are present in the particle mixture in a proportion of 5 to 95 percent by weight of the particle mixture.

In some aspects, the techniques described herein relate to a method of applying at least one aerogel-containing insulation layer to an article, wherein the insulation layer includes: aerogel particles; and at least one binder, including the steps of: providing the article to be coated; mixing the aerogel particles with the particles of a pulverulent binder and/or a pulverulent solid, for example expanded glass, to give a particle mixture; applying the particle mixture to the article to be coated by scattering, blowing or sucking the particle mixture onto the article to be coated; and activating the at least one binder of the at least one insulation layer, in order to provide a bond of the particle mixture to the article, wherein the aerogel particles are present in the particle mixture in a proportion of 5 to 95 percent by weight of the particle mixture, and wherein the article includes a textile surface to which the at least one aerogel-containing insulation layer is to be applied.

In some aspects, the techniques described herein relate to a method, wherein the method includes the applying of a binder that has not been premixed with the aerogel particles to the article.

In some aspects, the techniques described herein relate to a method, wherein the method includes the thermal heating of the particle mixture and/or of the article to be coated in order to activate and/or to cure the binder(s).

In some aspects, the techniques described herein relate to a method, wherein an additional protective layer can be applied at least to some regions of the insulation layer.

In some aspects, the techniques described herein relate to a method, wherein the article may include a textile surface to which the at least one aerogel-containing insulation layer is to be applied.

In some aspects, the techniques described herein relate to a method, wherein the step of applying the particle mixture to the textile surface is followed, in a further step, by applying the additional protective layer at least to the region of the article that has been provided with the particle mixture, wherein the protective layer especially includes a nonwoven that can be needled, pressed and/or bonded with the textile surface.

In some aspects, the techniques described herein relate to a method, wherein the aerogel particles include an SiO2 aerogel.

In some aspects, the techniques described herein relate to a method, wherein the aerogel particles have hydrophobic surface groups.

In some aspects, the techniques described herein relate to a method, wherein the aerogel particles, prior to the step of applying, are mixed with a pulverulent binder and/or a pulverulent solid, for example expanded glass, to give a particle mixture, in order to improve the ease of handling of the aerogel particles.

In some aspects, the techniques described herein relate to an article provided with at least one aerogel-containing insulation layer with the aid 1 to 9, wherein the insulation layer includes aerogel particles and at least one binder.

In some aspects, the techniques described herein relate to an article, wherein the insulation layer has been applied to an outer face of the article.

In some aspects, the techniques described herein relate to an article used for thermal insulation, fire protection, sound deadening, electrical insulation, and as heat shield, and/or for absorption or filtration of gases, vapors and liquids.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 shows a longitudinal section view of an article provided with an insulation layer according to a method of the present disclosure;

FIG. 2 shows an arrangement for applying an insulation layer to an article method according to the present disclosure; and

FIG. 3 shows a flow diagram of the production method according to the present disclosure.

### DETAILED DESCRIPTION OF PREFERRED EMBODIMENTS

Accordingly, what is proposed in accordance with the invention is a method of applying at least one aerogel-containing insulation layer to an article according to an embodiment of the present disclosure. Alternatively, what is proposed in accordance with the invention is a method of applying at least one aerogel-containing insulation layer to an article according to an embodiment of the present disclosure.

What is common to both methods is that the insulation layer comprises aerogel particles and a binder. The method comprises the steps of providing the article to be coated; mixing the aerogel particles with particles of a pulverulent binder and/or a pulverulent solid, for example expanded glass, to give a pulverulent particle mixture; applying the aerogel particles mixed with the pulverulent binder and/or the pulverulent solid (particle mixture) to the article to be coated by scattering the aerogel particles onto the article to be coated, and activating the binder of the at least one insulation layer in order to provide a bond to the article. The particle mixture includes the aerogel particles in a proportion of 5 to 95 percent by weight of the particle mixture.

According to another embodiment of the present disclosure, the article comprises a textile surface to which the at least one aerogel-containing insulation layer is to be applied. As well as the scattering mentioned, it is also possible to blow or suck the aerogel particles mixed with the pulverulent binder and/or the pulverulent solid (the particle mixture) onto the article to be coated.

According to the invention, articles or products that have especially been manufactured by the present methods may be provided subsequently with an insulation layer. The term “layer” does not refer here to a closed surface, but also includes the partial application, leaving gaps, of a particle mixture comprising aerogel particles. According to the invention, the aerogel particles that are crucially responsible for the thermal insulation need not be introduced into the article in the course of the production method, but may be applied subsequently thereto with the aid of a binder. The subsequent applying of an insulation layer thus significantly increases the scope of application of the present invention compared to the solutions known from the prior art. It will be appreciated that it is also possible to apply multiple insulation layers in this way if necessary.

The at least one insulation layer comprises both the aerogel particles and a binder. As will be set out in detail hereinafter, the binder can be applied separately to the article, for example by painting or knife coating, and/or in a mixture with the aerogel particles as a pulverulent powder mixture.

In addition, an inventive peculiarity of the present invention is considered to be that the aerogel particles in the particle mixture of the invention can be applied by scattering, blowing or sucking. As already set out at the outset, a significant advantage of aerogels is considered to be that they have very good insulation properties. These result especially from the particularly low density of aerogel materials, which varies, for example, within a range from 0.01 g/cm³ to 0.3 g/cm³. On account of their low density, however, pure aerogels and aerogel particles are extremely fragile and at the same time difficult to handle in further processing.

If attempts were made to scatter them onto a surface without special pretreatment, their own weight would be insufficient to enable controlled application to the surface. Instead, on account of their low density, they would be distributed in the air and, like dust particles, float in the air for a comparatively long period of time before being deposited—assuming that there are no air flows. Industrial processing/application in the desired manner would be possible only to a very limited degree, if at all. Furthermore, it has been found in practice that commercially available aerogel particles, for example aerogel-silicate particles, have a tendency to stick to the inner wall of a plastic vessel accommodating them, for example, even in the event of low occurrence of static electricity, as a result of which handling in industrial processing is again significantly complicated. For this purpose, the particles' own low weight is possibly also responsible for enabling an adhesion even in the case of low static attraction forces.

Therefore, the aerogel particles, according to the invention, prior to application to the article to be coated, are mixed with particles of a pulverulent binder and/or a pulverulent solid. The aerogel particles in the mixed state adhere to the particles of the powder added in a detachable manner. Factors responsible for this include microstructures on the particle surfaces that assist mechanical attachment. As the case may be, differences in charge and van der Waals forces may also have a supporting effect. As a result, the aerogel particles are weighed down by the adhering particles of the particle mixture, and the mixture of aerogel particles and the particles of the added powder can be applied, especially scattered, onto a surface of an article to be coated in a controlled manner with exploitation of weight and without the adverse effects and disadvantages of too low a density that have been mentioned. Because the particle mixture is pulverulent itself, very exact dosage of the aerogel particles per unit area can be achieved, without the particle mixture in the insulation layer entailing any significant adverse impairment for the user of the finished article in terms of the article properties, especially the surface properties, such as flexibility in the case of textiles, surface roughness and the like.

As an alternative to scattering, application by blowing or sucking (in the case of an air-permeable surface to be coated) of the particle mixture may also be employed for application of the aerogel particles, since the elevated weight of the particle mixture here too has been found to be advantageous for handling compared to the pure aerogel particles, although scattering has to date been found to be the simplest solution in practice.

The mixing of the particles can be effected in a wide variety of different ways and by means of any kind of mixing apparatus, for example in a closed mixing vessel into which the particles to be mixed are introduced and which can be moved for mixing of the particles (rotation, translation, oscillation and mixed forms thereof are conceivable). In addition, a stirrer element may also be provided within the mixing vessel, which can again be moved relative to the mixing vessel (here too, rotation, translation, oscillation and mixed forms thereof are conceivable). Another conceivable variant, in view of the low density of the aerogel particles, is mixing in a mixing vessel with the aid of heated air, especially since mixing in an air stream can be utilized for a particularly homogeneous mixing outcome and, in the case of a defined air temperature above the activation temperature, optionally for activation of the surface of binder particles (as described hereinafter as a conceivable embodiment). The mixing operation is conducted until there is a desired, approximately homogeneous distribution of the aerogel particles in the particle mixture. It is possible here to control the mixing operation either via its duration or, for example, via the speed or nature of the mixing movement of the mixing apparatus.

The added particles may be particles of a pulverulent binder. Binders are understood here to mean not just chemical binders in the narrower sense, but also, in the broader sense, substances that establish or promote chemical bonds at phase boundaries of other substances, or trigger or increase effects such as cohesion, adsorption and adhesion or friction. They bind substances by absorbing, adsorbing, retaining, crosslinking or bonding them, and include substances that are commonly referred to as adhesives. In addition, the binder of the invention may also comprise a binder system having multiple binders.

Binders having low thermal conductivity are preferred in the present context in order to achieve thermal insulation. If the article to be coated is not to have thermal insulation as its primary function, if at all, but is to provide sound insulation, for example, different binders may also be preferred. The binder is selected according to the desired properties of the article to be coated. For example, it is also possible to select a binder which has particularly low flammability or is non-combustible, in order to achieve a fire class of maximum favourability for the article to be coated. For example, it is possible to use silicone resin adhesives for the specific application.

According to the invention, the binder is used in the form of a solid powder in an addition to the aerogel particles. By virtue of the particles added likewise being pulverulent, the associated advantages, especially exact meterability of the aerogel particles, are maintained. This additionally achieves the effect that the particles of the pulverulent binder essentially do not penetrate into the interior of the porous aerogel particles and hence do not significantly impair the desired insulation properties. Alternatively or additionally, as already mentioned above, a binder may also be applied directly to the article in order to bind the powder mixture subsequently applied by scattering, comprising the aerogel particles and other pulverulent particles, to the article surface.

Binders in the context of the present invention may thus, for example, be either physically setting or chemically curing one-component adhesives, and chemically curing two- or multicomponent adhesives. Examples of such binders include hotmelt adhesives, dispersion-based adhesives, solvent-based adhesives, plastisols, thermally curing epoxy resins, reactive hotmelt adhesives such as ethylene-vinyl acetate copolymers and polyamides, formaldehyde condensates, polyimides, polybenzimidazoles, cyanoacrylates, polyvinylalcohols, polyvinylbutyrals, polyethylene waxes, anaerobic adhesives, moisture-curing silicones and light- and UV-curing systems, methacrylate, two-component silicones, cold-curing epoxy resins and cold-curing polyurethanes.

In addition, binders in the context of the present invention may, for example, also be transparent or translucent plastics such as polymethylmethacrylates (PMMA, e.g. Degalan™, Plexiglas™), cycloolefin copolymers (COC, e.g. Topas™), polyvinylbutyrals (e.g. Mowital™), polycarbonates and polyethylene terephthalates (PET, e.g. Hostaglas™), preference being given to polyvinylbutyrals, polyvinylalcohols and polymethylmethacrylates.

In addition, binders in the context of present invention may also be fibrous by nature, for example bicomponent fibres.

The particle mixture comprising the aerogel particles and the particles of a pulverulent binder and/or a pulverulent solid comprises at least 5 to 95 percent by weight of aerogel particles, preferably 5 to 70 percent by weight, more preferably 30 to 65 percent by weight and especially 40 to 60 percent by weight of the particle mixture.

The insulation layer may, in addition to the materials mentioned, also include further materials and substances; for example, in order to achieve particular properties, it is possible to use additional amounts of binding accelerators, lubricants, pigments, plasticizers or curing accelerators. For example, in order to achieve a fire class of maximum favourability, it is possible to use materials and methods that are known to the person skilled in the art, for example flame retardants, fire protection paints and coatings, films and laminations. In particular, this may also include a protective layer which is capable of protecting at least the region with the aerogel particles applied from outside influences, for example mechanical abrasion or the like, and can be applied to the aerogel particles applied.

As an alternative to the particles of a pulverulent binder or in addition, the particle mixture may also contain particles of another pulverulent solid, for example expanded glass particles or the like. The use of expanded glass has the advantage that this material is comparatively inexpensive to produce and is associated with many advantages in use. Expanded glass is obtained from recycled used glass and is already being employed in the production of lightweight concrete, lightweight render, lightweight brick mortar, and in thermal insulation panels, thermal insulation beds, plaster baseboard, curtain wall systems and decorative paints. Expanded glass is foamed glass having small gas-filled pores and can be produced in grain sizes of 0.04-16 mm. The pelletized material has a closed lattice structure. By contrast with sharp-edged broken (crushed) foam glass, which is produced in a similar process, but compacted under pressure, expanded glass (pellets) consist of spheres/round grains that enable processing in a versatile manner. Beds of expanded glass are very lightweight and nevertheless pressure-resistant, thermally insulating, alkali-resistant and noncombustible, have high durability and are not attacked by rodents, pests and fungi.

In one conceivable embodiment, the binder that has been mixed in particle form with the aerogel particles may simultaneously also be that used for binding of the aerogel particles to the article to be coated. Binders of particular interest here are especially those that can be activated and/or cured by thermal warming or heating. However, alternative configurations in which other mechanisms of activation are used are likewise conceivable.

In one embodiment, it is possible, for example, before, during and/or after the mixing of the particles, to activate, especially to heat, the particle mixture or the binder particles. This makes the binder particles tacky and achieves improved adhesion to the aerogel particles. Nevertheless, the mixture can still remain in powder form by keeping the heating brief and only superficially heating the binder particles. The particle surface of the binder particles which is tacky as a result is wetted by the aerogel particles as a result of the adhesion thereof, and the mixture remains scatterable and pulverulent.

The mixture may correspondingly be scattered onto the article to be coated in a further step, for example onto a textile surface, and subsequently heated to such an extent, or are heated further, that the binder particles are reactivated or further activated and enable reliable attachment of the aerogel particles to the article surface. According to the desired type of binder, it can be solidified and hardened by mere cooling of the binder below the melting temperature or with the aid of further measures, for example by further heating, use of UV rays or the like. The aerogel particles are cohesively bonded in this way to the surface of the article to be coated.

Alternatively or additionally, a binder may be applied to the article to be coated separately from the particle mixture. The binder here may be of the same type as that which can be added to the aerogel particles in powder form, or may be of a different type. In particular, the binder here may be in non-solid and/or non-pulverulent form, in order to simplify attachment of the particle mixture to the article to be coated. For example, it is possible to apply a spreadable binder, in liquid or paste form, to the article to be coated. It is also conceivable that the article has been impregnated with a binder or has been coated with a binder in the manner of an adhesive web that enables the adhesion of the particle mixture applied. It is also possible for the article to have a surface that acts as a binder through activation, especially through thermal heating; for example, in the case of a textile surface, this may comprise fibres that are suitable through thermal activation for attaching the particle mixture to the textile surface.

In the selection of this binder to be applied to the article to be coated too, preference is given to choosing one or more that essentially do(es) not penetrate into the interior of the porous aerogel particles. The penetration of the binder into the interior of the aerogel particles may be influenced not only by the selection of the binder but also by the control of temperature and the processing time.

As outlined above, the step of activating the binder may comprise the thermal heating of the particle mixture and/or the article to be coated, in order to activate and/or subsequently to solidify the binder(s). For example, the particle mixture may be heated in order to improve the adhesion of the particles, especially the aerogel particles, to the binder particles added and/or to the pulverulent solid-state particles and in this way to improve the ease of handling of the particle mixture. Alternatively or additionally, the article to be coated may also be heated together with the particle mixture already applied and/or prior to the application of the particle mixture, for example in order to activate a binder additionally applied to the article or to activate the particle mixture applied to the article. It is also possible to cure the insulation layer, depending on the nature of the binder(s) used, by means of thermal heating. Alternatively, the insulation layer may, however, also be solidified by, for example, cooling, the use of UV light or other known means.

As already stated, a method of improving the ease of handling of aerogel particles is also provided, in order, for example, to be able to apply them to the article by scattering, blowing or sucking for application of at least one aerogel-containing insulation layer to an article by the method described above, wherein the aerogel particles, prior to the step of application, are mixed with a pulverulent binder and/or a pulverulent solid, for example expanded gas, to give a particle mixture. In this way, the comparatively very light aerogel particles are weighed down by the adhering further pulverulent substance particles that stick detachably to the aerogel particles in the mixed state. Among the features responsible for this are microstructures on the particle surfaces that assist mechanical adhesion. It may be the case that differences in charge and van der Waals forces also have a supporting effect. The outcome is that the aerogel particles are weighed down by the adhering particles of the particle mixture and the mixture of aerogel particles and the particles of the added powder can be used in industrial processing methods without the adverse effects and disadvantages of too low a density that have already been mentioned above.

As already described above, the aerogel particles are detachably bonded to the particles of the pulverulent binder and/or the pulverulent solid at least through physical adhesion in the particle mixture. In addition, slight activation of the pulverulent binder can also achieve improved adhesion.

In one development of the invention, the aerogel particles may have an open porosity with an air content of up to 99%, especially an air content of about 95%. The aerogel particles may especially have a density of below 1 g/cm³, for example below 0.5 g/cm³ and particularly advantageously below 0.15 g/cm³. The aerogel particles may have pores having a pore size in the range from 2 to 50 nm (mesoporous particles), preferably in the range of 20-40 nm. In addition, the aerogel particles themselves may have different sizes within a range of, for example, 5 μm to 5 mm, especially within a range of 8 μm to 4 mm.

Alternatively or additionally, the article to be coated may comprise a textile surface to which the at least one insulation layer is to be applied. Textile surfaces utilized may be all kinds of textiles, irrespective of the manner of manufacture, the structure of the material or the recovery of the starting materials, meaning that the textile surface comprises any form of textile fabric, i.e. fabric made of fibres, such as felts, webs and batting, and filaments, such as braids, weaves, meshes, loop-drawn knits and loop-formed knits. In addition, these may comprise fibres obtained from synthetic or natural raw materials. The textile surface may have been produced by loop-drawn knitting, weaving, spinning, felting, loop-formed knitting, laying or fulling.

In one development of the invention, it is additionally possible to influence the properties of the article via the configuration of the textile surface as carrier layer for the at least one insulation layer. For instance, it is also possible here to use noncombustible or low-flammability carrier materials, for example melamine resin fibres or the like, in order to increase the fire retardancy of the article. It is also possible, for example, to improve the mechanical strength of the article or the insulating action through choice of a suitable carrier material as textile surface and through the choice of processing method of the textile surface.

In one development of the invention, the insulation layer may comprise an additional protective layer that serves to protect the aerogel particles from outside influences. For instance, it is possible to protect the insulation layer by providing an additional protective layer at least in some regions. The additional protective layer may, for example, be an additional textile protective layer, for example in the form of a nonwoven layer or batting. Alternatively or additionally, the additional protective layer may also comprise a non-textile layer, for example a foam or a foil. For securing to the insulation layer, the additional protective layer, depending on the type of protective layer and configuration of the insulation layer, may be bonded, pressed and/or needled to the insulation layer.

For example, in the case of a textile surface of the article that has been provided with the insulation layer, it is possible to place a nonwoven or batting onto the textile surface as an additional protective layer after the application of the insulation layer and to needle it to the textile surface. In this way, it is possible to interloop the fibres of the nonwoven or batting with one another and with those of the textile surface, by means of which the nonwoven is secured to the textile surface and the fibres thereof are at the same time consolidated and strengthened by inserting and removing a multitude of specific needles (barbed hook needles, fork needles or the like) disposed in a needle board or needle bar.

Alternatively or additionally, the additional protective layer may also be bonded to the insulation layer, especially to the binder present therein, directly or by means of an additional binder. For instance, it is possible to place the protective layer onto the insulation layer, while the binder in the insulation layer or an additional binder in the interfacial region between the protective layer and insulation layer is activated and optionally reliably bonded thereto by additional pressing. It is also possible for the protective layer itself to contain an activatable binder for bonding to the insulation layer.

By means of the additional protective layer, it is possible, for example, to avoid mechanical abrasion of the insulation layer applied, which can be particularly advantageous when the textile surface of the article can be subject to severe mechanical stresses in use. In addition, the additional layer can further improve the insulating effect. Depending on the choice of protective layer, especially of the textile protective layer, it is also possible to improve further properties of the article, as well as mechanical strength and insulating action; for example, it is possible to use noncombustible or low-flammability fibres in order to increase fire retardancy.

The additional textile protective layer used may of course also, in addition to the nonwoven given as an example, be a textile of any conceivable kind, irrespective of the manner of manufacture, the structure of the textile fabric or the way in which the starting substances were obtained, i.e. the textile protective layer may comprise fabrics made of fibres, such as felts, webs and batting, and fabrics made of filaments, such as braids, weaves, meshes, loop-drawn knits and loop-formed knits. In addition, these may comprise fibres obtained from synthetic or natural raw materials. The textile protective layer may have been produced by loop-drawn knitting, weaving, spinning, felting, loop-formed knitting, laying or fulling.

In this connection, for the sake of completeness, it should be mentioned that, even in the case of application of at least one aerogel-containing insulation layer to a non-textile surface, it may be advantageous to apply or place an additional protective layer onto the particle mixture applied in order to protect it, for example, from abrasion and/or other outside effects. Such a protective layer may comprise a solid structure, such as the above-described nonwoven layer, for example a textile protective layer, a film or the like, which may be bonded to the article, a foam or a coating to be applied, such as an impregnation, a protective lacquer or the like. In the selection of the protective layer, it should of course be ensured that these have only a slight adverse effect, if any, on the desired properties of the aerogel particles.

In one development of the invention, the aerogel particles may especially comprise a silicate aerogel (SiO₂ aerogel). This material has a multitude of positive properties such as low flammability, low electrical conductivity and very low thermal conductivity. In addition, the material is non-toxic and transparent or see-through, and elastic, which means that it can be used in a multitude of conceivable applications and articles, for example in the sector of functional textiles, heat-insulating vessels and housings (for example of electrical equipment), and in the household and the like.

Alternatively or additionally, the aerogel particles may comprise graphite, plastic (e.g. resorcinol-formaldehyde RF, polyurethane PU, polyester PES) and biopolymers (e.g. lignin, cellulose).

In one development of the invention, the aerogel particles may have hydrophobic surface groups. In order to prevent later collapse of the aerogels as a result of condensation of moisture in the pores, it is advantageous when hydrophobic groups are present in covalent form, especially on the inner surface of the aerogels, and these are not eliminated under the action of water. Preferred groups for lasting hydrophobization are trisubstituted silyl groups of the general formula —Si(R)³, more preferably trialkyl- and/or triarylsilyl groups, where each R is independently a non-reactive organic radical such as C₁-C₁₈-alkyl or C₆-C₁₄-aryl, preferably C₁-C₆-alkyl or phenyl, especially methyl, ethyl, cyclohexyl or phenyl, which may additionally be substituted by functional groups. The use of trimethylsilyl groups is particularly advantageous for lasting hydrophobization of the aerogel. The introduction of these groups can be effected as described in WO 94/25149, or be accomplished by gas phase reaction between the aerogel and, for example, an activated trialkylsilane derivative, for example a chlorotrialkylsilane or a hexaalkyldisilazane (cf. R. Iler, The Chemistry of Silica, Wiley & Sons, 1979).

In one development of the invention, it may be the case that the aerogel particles have a thermal conductivity of less than 25 mW/mK, especially of less than 15 mW/mK, for example of 12 mW/mK.

The invention additionally also relates to a coated article to which at least one aerogel-containing insulation layer has been applied with the aid of a method as described above, wherein the insulation layer comprises aerogel particles and a binder.

It may further be the case that the insulation layer has been applied to an outer face of the finished article.

It may further be the case that the finished article comprises a textile, wherein the proportion of the aerogel particles on the coated article is at least 0.5 percent by weight.

Finally, the present invention relates to the use of a coated article as described above in the field of thermal insulation, fire protection, sound deadening, electrical insulation, and/or in the field of absorption of gases, vapours and liquids. The term “thermal insulation” refers here to the reduction of the passage of thermal energy through the at least one insulation layer in order to protect a room or a body from cooling or heating.

It should additionally be pointed out that words such as “comprising”, “have” or “with” do not rule out any other features or steps. Moreover, the words “a” or “the” referring to one step or feature do not rule out a multitude of features or steps, and vice versa.

Further features and advantages of the invention will be apparent from the description of a working example of the invention that follows, and from the subsidiary disclosures.

The invention is described in detail hereinafter with reference to the appended figures. The figures show multiple features of the invention in combination with one another. The person skilled in the art, however, is also capable of considering these separately from one another and may combine these to form further viable sub-combinations without having to exercise inventive skill in so doing.

FIG. 1 shows, in a highly schematized manner, an article that has been provided with an aerogel-containing insulation layer by the method of the present invention. It is essential to the invention here that the aerogels are present in the insulation layer in particle form and can be applied to a finished article without having to subject the latter subsequently to a complex drying process for production of the aerogel structure. According to the invention, the aerogel particles are scattered, blown or sucked onto the article.

For this purpose, they have to be made easy to handle since the aerogel particles, as a result of their specific structure and their own very low weight, have a tendency to spread in the air and to float in the air like dust particles for a long period of time before being deposited—assuming that there are no air flows. Industrial processing/application in the manner desired, i.e., for example, without addition of a solution, would be possible only to a very limited degree, if at all. Furthermore, it has been found in practice that commercially available aerogel particles, for example silicate particles, have a tendency to stick, for example, to the inner wall of a plastic vessel that accommodates them even in the event of low occurrence of static electricity, as a result of which the handling thereof in industrial processing is again significantly complicated.

As can be seen from FIG. 1, the article in the present illustrative embodiment comprises a spunlace web 10 to which an insulation layer 20 has been applied. In this type of nonwoven material, water jets cause vortexing, interlooping and consolidation of webs introduced under a high pressure. This type of mechanical consolidation produces a very uniform pore structure. The application of at least one insulation layer of the invention to other surfaces is of course likewise possible. The article to be contacted with at least one aerogel-containing insulation layer here is not restricted to articles having a textile surface; instead, it may include all conceivable types of materials and shapes. What is crucial here is that the aerogel particles are not introduced into the article, the nonwoven material in the present case, in the course of the production process, but are applied thereto thereafter.

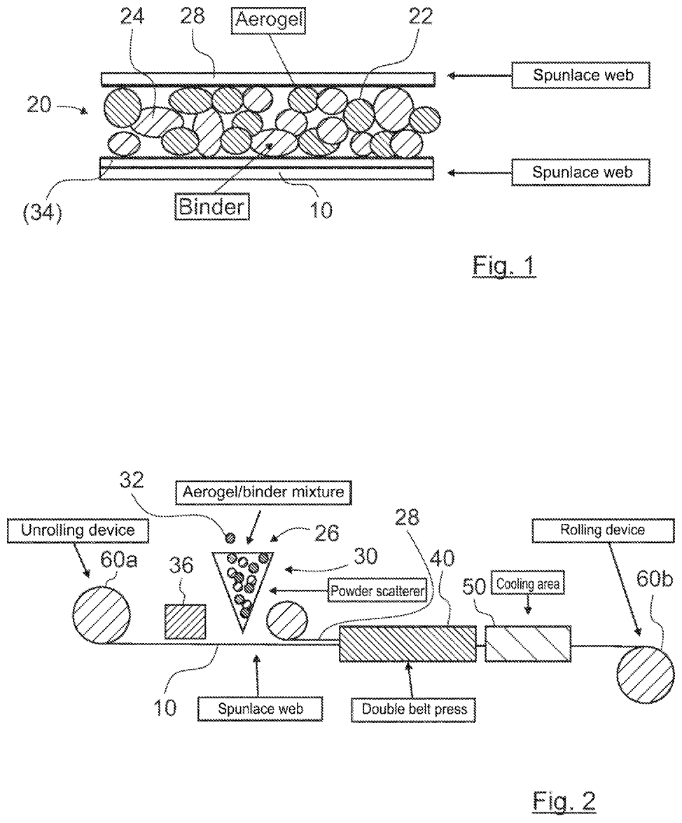

The insulation layer 20 in the illustrative embodiment shown again comprises both the aerogel particles (in FIG. 1: “Aerogel”) 22 and a binder introduced in particle form (in FIG. 1: “Binder”) 24. In the method according to the invention, the aerogel particles 22 and the particulate binder 24 are mixed with one another to give a particle mixture 26, which is applied to the article, in the present context to the spunlace web 10. Alternatively or additionally to the binder particles 24, it is also possible to mix particles of a pulverulent solid, e.g. expanded glass particles (indicated by reference numeral 32 in FIG. 2) with the aerogel particles 22.

In addition, the premixed particle mixture 26, as shown in FIG. 2, may be scattered by means of a scattering device (in FIG. 2: “powder scatterer”) 30 onto the spunlace web 10 that has been unrolled by an unrolling device. Another conceivable alternative would be to blow the particle mixture 26 onto the spunlace web 10 or to suck it through the spunlace web 10.

In the embodiment shown in FIG. 2, it is possible to provide a relatively large surface of an article with an aerogel-containing layer 20 by continuously moving the surface, for example by means of the unrolling device 60a and rolling device 60b shown, under the scattering device 30. Alternative conveying devices are of course likewise conceivable, such as the batchwise application of an aerogel-containing insulation layer to individual articles.

The binder particles 24 of the particulate or pulverulent binder 24 may be similar in terms of size to the particle size of the aerogel particles 22, as shown in FIGS. 1 and 2, or may differ in being distinctly larger or smaller. All that is crucial is that the particles 24 or 32 of the particle mixture 26 that have been added to the aerogel particles 22 are capable of at least partial adhesion to the aerogel particles 22 in order to increase their ease of industrial handling, especially scattering, and that the particle mixture is composed of pulverulent components for good dosability.

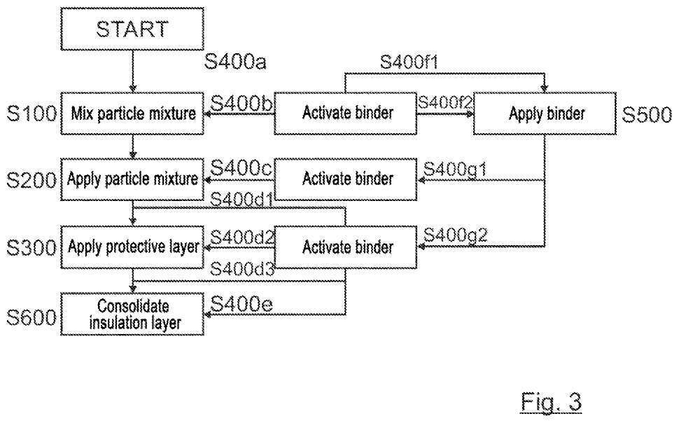

It is conceivable that the mechanical adhesion of the aerogel particles 22 to the added particles 24 (and the charge adhesion) is supplemented by, for example, cohesive adhesion. For example, the binder particles 24 may be activated by thermal heating and in this way display a binding effect at their surface, which enables, for example, cohesive adhesion of the aerogel particles 22. It is possible here for a first heating or activation to take place even prior to the mixing (FIG. 3: step S100) with the aerogel particles 22 (FIG. 3: step S400a), such that the binder particles (24) are added in the already activated state and mixed with the aerogel particles (22), or in the course of mixing (FIG. 3: S100) of the particle mixture (FIG. 3: step S400b). In addition, the activating of the binders in the particle mixture 26 can also be undertaken during the application of the particle mixture 26 (FIG. 3: S200), for example on blowing with warm air or with the aid of a UV lamp or the like (step S400c). Alternatively or additionally, the activation can also be effected before, during or after the applying of a protective layer (FIG. 3: step S300) (S400d₁₋₃). Finally, the activation can also be effected at the same time as the step of consolidating the insulation layer 20 in step S600 (step S400e). In this case, the activation and subsequent curing of the binder can be undertaken in one operation, for example by heating.

In order to enable adhesion and fixing of the particle mixture 26 applied on the surface of the article, i.e. in the present context on the surface of the spunlace web 10, the composite of article 10 and particle mixture 26 may be heated in a method step that follows the applying (FIG. 3: S200) and optionally compressed, for example in a double belt press 40, as shown in FIG. 2. By virtue of the warming or heating of the composite of article 10 and particle mixture 26, the added binder 24 may be activated (optionally reactivated or further activated) and may be bonded both to the fibres of the spunlace web 10 and also (optionally further) to the aerogel particles 22. The compressing of this composite additionally enables reduction of the cavities between the particle mixture and the article surface and hence improves the binding action. The binder particles 24 may (if present), according to the desired result and according to the use in the composite, be fully melted together with the article or else be only partly warmed for activation and still be present at least partly in particulate form in the applied and fixed insulation layer.

After heating, the finished product may be cooled, for example, in a cooling area 50, as shown in FIG. 2, for consolidation of the insulation layer. Alternatively, depending on the binder used, it is also possible to conduct a drying process or a curing process in step S600 for consolidation of the insulation layer.

The illustrative embodiment shown in FIG. 2 shows a method according to the invention for application of an aerogel-containing insulation layer to a textile surface of an article. It is of course also possible to provide other surfaces correspondingly with an aerogel-containing insulation layer. In addition, in the embodiment shown, a pulverulent binder has been added to the aerogel particles 22. Alternatively or additionally, it is also possible to mix in other particulate solids. For instance, it is conceivable that, rather than the binder particles 24 or in addition to these, expanded glass particles (FIG. 2: reference numeral 32) are mixed into the aerogel particles 22. Here too, at least mechanical adhesion to the aerogel particles takes place, which weighs down the aerogel particles and hence makes them more easily processible.

In a variant in which no binder particles 24 are present in the particle mixture 26, binding to the surface of the article intended for application can be effected by means of a binder applied to the article (indicated by reference numeral 34 in FIG. 2). Depending on the nature of the binder chosen, this can be applied by painting, spraying or laying by means of an optional application device 36, for example to the surface of the article intended for application (step S500). In addition, the binder 34 may already be activated prior to the application (S400f₁) and/or activated during the application (S400f₂). In a further step, the particle mixture 26 may then be applied thereto, or the binder is only applied with the particle mixture 26 or in the course of one of the subsequent method steps and/or is only activated in conjunction with the particle mixture 26 applied (shown by way of example as S400g), for example by heating.

It is of course also possible to combine the variant in which a binder 34 is applied to the surface of the article 10 intended for application with the embodiment in which a particulate binder (also binder particle 24) has been added to the particle mixture 26. In this case, the binder particles 24 may or may not be of the same chemical type or similar to the binder 34 applied to the surface of the article 10.

For further stabilization and for protection of the insulation layer 20 on the article, it is possible to place a further protective layer, for example a textile protective layer in the form of a nonwoven, here a spunlace web 28 (FIG. 2), onto the composite of particle mixture 26 and article surface. This can be heated and compressed together with the composite of particle mixture 26 and article 10. In order to increase stability, the additional protective layer may also be needled and/or bonded to a textile surface of the article, such as the spunlace web 10 in the embodiment shown (not shown).

By way of further elucidation, some examples of the method according to the invention are adduced hereinafter. The method steps are designated according to FIG. 3.

More particularly, it can also be seen in FIG. 3 that the step of activating the binder S400 can be effected at different junctures (and also more than once). For instance, the pulverulent binder 24 may be activated, for example by means of a warm air stream, even before or on addition to the aerogel particles 22 (S400a), during the mixing of the particle mixture in S100 (S400b) or on application of the particle mixture 26 to the article 10 in step S200 (S400c). It is also possible for the pulverulent binder 24 as part of the particle mixture 26 applied to the article 10 to be activated only shortly before, on or after application of the protective layer in method step S300 (S400d₁₋₃) or on consolidation of the insulation layer in S600 (S400e).

The binder 34, which can be applied to the article 10 separately from the aerogel particles 22, may in turn be activated before or during the applying of the binder S500 (S400f₁₋₂) or thereafter (S400g₁₋₂). In this case, the manner of activation may also play a role. If the binder 34, for example, becomes spreadable only by virtue of its activation, activation before the application or during the application (S400f) is advisable. If, meanwhile, the binder 34 is applicable to the article irrespective of its activation, for example provided in the form of an impregnation on the surface of the article 10, an activation (optionally a reactivation) after the application of the binder 34 may then also be advantageous (S400g₁₋₂).

In a first example, in step S100, 50 g of a polyurethane hotmelt (as particulate binder 24) is mixed with 30 g of aerogel silicate particles 22 at 80° C. to give a particle mixture 26, as shown in FIG. 2. The particle mixture 26 is scattered in a second step S200 onto a 60 g/m² spunlace web 10 (with an applied weight of 80 g/m²) and, in a further step S300, covered with a second web 28. The two plies of spunlace web 10 and 28 together with the intervening layer of binder particles 24 and aerogel particles 22 are then compressed under pressure in a subsequent step at 150° C. for 60 seconds (0.6 N/cm²). The heating under pressure serves here for further activation of the binder 24 (S400d₃). In the course of subsequent cooling, the insulation layer 20 solidifies in a final step S600.

In a second example, in a first step S100 at ambient temperature, 60 g of a terpolymer hotmelt (as binder particles 24) is mixed with 60 g of aerogel silicate particles 22. In a further step S200, the particle mixture 26 is then scattered onto a 50 g/m² spunlace web 10 (with an applied weight of 120 g/m²) and, in a subsequent step S300, covered with a second web 28. The two plies of spunlace web 10 and 28 together with the intervening layer of binder particles 24 and aerogel particles 22 are then compressed under pressure at 160° C. for 45 seconds (0.6 N/cm²). The heating under pressure serves in turn to activate the binder 24 (S400d₃). In the course of subsequent cooling, the insulation layer 20 solidifies in a final step S600.

In a third example, in a first step S100 at ambient temperature, 30 g of aerogel silicate particles 22, 30 g of expanded glass (having a diameter of about 0.1-0.3 mm as pulverulent solid-state particles) and 30 g of hotmelt (as particulate binder 24) are mixed with one another to give a particle mixture 26. In parallel or with a time delay, in a step S500, a 50 g/m² spunlace web 10 is coated by means of a slot die (as application device 36) with an activated (S400f) EVA hotmelt as further binder 34. The applied weight/layer thickness is 20 g/m². In a subsequent step S200, the particle mixture 26 is scattered into the liquid binder 34 applied to the article 10 (with an applied weight of 60 g/m²). In a further step S300, the composite composed of article 10 with binder coating and scattered particle mixture 26 is covered with a second web 28 and compressed under pressure at 150° C. for 45 seconds (0.6 N/cm²). The heating under pressure serves here both for further activation of the binder 34 (S400g₂) and for activation of the particulate binder 24 (S400d₃). On subsequent cooling, the insulation layer 20 solidifies in a final step S600.

In a fourth example, in a first step S100 at ambient temperature, 3 g of aerogel silicate particles 22 and 5 g of corundum (as pulverulent solid-state particles) are mixed with one another to give a particle mixture 26. In parallel or with a time delay, in a step S500, a 30 g/m² paper (as article 10) is impregnated with a melamine resin (as further binder). In a further step S200, the particle mixture 26 is then scattered into the as yet undried melamine film (with an applied weight of 8 g/m²). Subsequently, the impregnated paper with the particle mixture 26 applied by scattering is dried at 140° C. for 60 seconds, i.e. the melamine film is cured. The heating under pressure serves here to consolidate the insulation layer 20 in a final step S600.

TABLE 1
values ascertained for thermal resistance for examples 1, 2 and 5

| | Thermal resistance | Thermal resistance |
|---|---|---|
| | in 10⁻³ [Km²W⁻¹] | in 10⁻³ [Km²W⁻¹] |
| Example | with aerogel | without aerogel |
| 1 | 50 | 24 |
| 2 | 85 | 22 |
| 5 | 80 | 30 |

In a fifth example, in a first step S100 at ambient temperature, 50 g of a terpolymer hotmelt (as binder particles 24) is mixed with 50 g of aerogel silicate particles 22. In a further step S200, the particle mixture 26 is then scattered onto a 50 g/m² spunlace web 10 (with an applied weight of 90 g/m²) and, in a subsequent step S300, covered with a second web 28. The two plies of spunlace web 10 and 28 together with the intervening layer of binder particles 24 and aerogel particles 22 are then compressed under pressure at 160° C. for 45 seconds (0.6 N/cm²). The heating under pressure serves in turn to activate the binder 24 (S400d₃). In the course of subsequent cooling, the insulation layer 20 solidifies in a final step S600.

After this process, the bonded article is additionally mechanically consolidated in a needling process.

In a sixth example, in a first step S100 at ambient temperature, 50 g of a flame-retardant hotmelt (as binder particles 24) is mixed with 30 g of aerogel silicate particles 22. In a further step S200, the particle mixture 26 is then scattered onto a 50 g/m² Pyrotex spunlace web 10 (with an applied weight of 80 g/m²) and, in a subsequent step S300, covered with a second (identical) web 28. The two plies of spunlace web 10 and 28 with the intervening layer of binder particles 24 and aerogel particles 22 are then compressed under pressure at 160° C. for 45 seconds (0.6 N/cm²). The heating under pressure serves in turn to activate the binder 24 (S400d₃). In the course of subsequent cooling, the insulation layer 20 solidifies in a final step S600.

After this process, the bonded article is additionally mechanically consolidated in a needling process.

1. A method of applying at least one aerogel-containing insulation layer to an article, wherein the at least one insulation layer comprises aerogel particles and at least one binder, the method comprising the steps of:
providing the article to be coated;
mixing the aerogel particles with particles of a pulverulent binder and/or a pulverulent solid, for example expanded glass, to give a particle mixture;
applying the particle mixture to the article to be coated by scattering the particle mixture onto the article to be coated; and
activating the at least one binder of the at least one insulation
layer, in order to provide a bond of the particle mixture to the article, wherein the aerogel particles are present in the particle mixture in a proportion of 5 to 95 percent by weight of the particle mixture.

2. The method of claim 1, wherein applying the particle mixture to the article to be coated further comprises blowing or sucking the particle mixture onto the article to be coated, and
wherein the article comprises a textile surface to which the at least one aerogel-containing insulation layer is to be applied.

3. The method according to claim 1 further comprises: applying a binder(s) that has not been premixed with the aerogel particles to the article.

4. The method according to claim 3, further comprises:
thermal heating of the particle mixture and/or of the article to be coated in order to activate and/or to cure the binder(s).

5. The method according to claim 1, wherein an additional protective layer is applied at least to some regions of the at least one insulation layer.

6. The method according to claim 5, wherein the article comprises a textile surface to which the at least one aerogel-containing insulation layer is to be applied.

7. The method according to claim 6, further comprising the step of:
applying the additional protective layer at least to a region of the article that has been provided with the particle mixture,
wherein the protective layer further comprises a nonwoven region that can be needled, pressed and/or bonded with the textile surface.

8. The method according to claim 1, wherein the aerogel particles comprise an SiO₂ aerogel.

9. The method according to claim 1, wherein the aerogel particles have hydrophobic surface groups.

10. A method of improving ease of handling of aerogel particles to be applied to an article for application of at least one aerogel-containing insulation layer to the article, the method comprising the steps of:
providing the article to be coated;
mixing the aerogel particles with a pulverulent binder and/or a pulverulent solid, for example expanded glass, to give a particle mixture, in order to improve the ease of handling of the aerogel particles;
applying the particle mixture to the article to be coated by scattering the particle mixture onto the article to be coated; and
activating the at least one binder of the at least one insulation layer, in order to provide a bond of the particle mixture to the article,
wherein the aerogel particles are present in the particle mixture in a proportion of 5 to 95 percent by weight of the particle mixture.

11. The method according to claim 10, wherein the at least one insulation layer of the article comprises aerogel particles and at least one binder.

12. The method according to claim 11, wherein the at least one insulation layer is applied to an outer face of the article.

13. The method according to claim 11, wherein the article is a heat shield.

14. The method of claim 12, wherein the article is configured to absorb or filter gases, vapours and liquids.

15. A method of applying at least one aerogel-containing insulation layer to an article, wherein the at least one insulation layer comprises aerogel particles and at least one binder, the method comprising the steps of:
providing the article to be coated;
mixing the aerogel particles with particles of a pulverulent binder and/or a
pulverulent solid, for example expanded glass, to give a particle mixture;
applying the particle mixture to the article to be coated by scattering the particle mixture onto the article to be coated; and
activating the at least one binder of the at least one insulation layer, in order to provide a bond of the particle mixture to the article, wherein:
the article comprises a textile surface to which the at least one insulation layer is to be applied, and
the aerogel particles are present in the particle mixture in a proportion of 5 to 95 percent by weight of the particle mixture.

16. The method according to claim 15 further comprises:
applying a binder that has not been premixed with the aerogel particles to the article.

17. The method according to claim 15 further comprises:
thermal heating of the particle mixture and/or of the article to be coated in order to activate and/or to cure a binder(s).

18. The method according to claim 15, wherein an additional protective layer is applied at least to some regions of the at least one insulation layer.

19. The method according to claim 18, wherein the aerogel particles comprise an SiO₂ aerogel.

20. The method according to claim 19, further comprising the step of:
applying the additional protective layer at least to a region of the article that has been provided with the particle mixture,
wherein the protective layer further comprises a nonwoven region that can be needled, pressed and/or bonded with the textile surface.
